(19) United States
(12) Patent Application Publication
(10) Pub. No.: US 2024/0168475 A1
(43) Pub. Date: May 23, 2024

(54) Monitoring Apparatus and Method

(71) Applicant: Hitachi Industrial Equipment Systems Co., Ltd., Chiyoda-ku, Tokyo (JP)

(72) Inventors: Masashi KONO, Tokyo (JP); Yuusuke NAKAGAWA, Tokyo (JP); Nobuhiro TOTTORI, Tokyo (JP)

(21) Appl. No.: 18/282,833

(22) PCT Filed: Mar. 18, 2022
(86) PCT No.: PCT/JP2022/012908

§ 371 Date: Sep. 19, 2023

(30) Foreign Application Priority Data
Mar. 29, 2021 (JP) 2021-055369

(51) Int. Cl. G05B 23/02

(52) U.S. Cl. CPC G05B 23/0283; G05B 23/0224; G05B 23/0272

(57) ABSTRACT

Designation of equipment identifying information for identifying object equipment that is the equipment which is an analysis object, and an analysis item to be analyzed regarding the object equipment is accepted; data of a data type which is required to analyze the accepted analysis item is acquired and a current equipment status of the object equipment is decided based on the acquired data; a diagnosis score for evaluating a current status of the object equipment as a score is calculated based on the decided equipment status of the object equipment and a diagnosis result of the object equipment is decided on the basis of the calculated diagnosis score; and the decided diagnosis result of the object equipment is visualized.

### TECHNICAL FIELD

The present invention relates to a monitoring apparatus and method and is suited for application to, for example, a monitoring apparatus for monitoring the status of equipment such as industrial equipment.

### BACKGROUND ART

In recent years, industrial equipment maintenance methods have been making the transition from time-based maintenance to perform maintenance regularly to condition-based saving to perform maintenance in accordance with the condition or status of each equipment. In order to perform the condition-based maintenance, it is necessary to always monitor object equipment. Accordingly, remote monitoring services using IoT (Internet of Things) clouds are spreading.

Conventionally, a technology disclosed in PTL 1 is known as a technology relating to a monitoring apparatus for monitoring equipment and detecting predictive failure signs. This PTL 1 discloses that: monitoring data of a monitoring object system during a time period in which no anomaly was detected regarding the monitoring object system is sorted by each day of week, time slot, date, or the number of weeks and is stored in a storage unit; an allowable range is set based on distribution of the stored monitoring data on the basis of each day of week, time slot, date, or the number of weeks; the monitoring data currently acquired from the monitoring object system is compared with the allowable range based on the distribution of the monitoring data of the week of day, time slot, date, or the number of weeks to which the current date and time belong; and if the acquired monitoring data exceeds an upper limit or lower limit of the allowable range, a predictive failure sign of the monitoring object system is detected.

### CITATION LIST

### Patent Literature

PTL 1: Japanese Patent Application Laid-Open (Kokai) Publication No. 2014-153736

### SUMMARY OF THE INVENTION

### Problems to be Solved by the Invention

However, such PTL 1 only discloses the technology that implements the processing for detecting the predictive failure sign by using an appropriate threshold value according to an operating status of a computer system which is a monitoring object. In other words, such PTL 1 only judges the predictive failure sign on the basis of whether the monitoring result of the monitoring object equipment exceeds the threshold value or not, so that a means for judging the status of the equipment within the allowable range is not considered. However, there is a demand for the judgment on not only whether a failure has occurred or not, but also the current status of the equipment in order to perform the condition-based maintenance of the industrial equipment.

The present invention was devised in consideration of the above-described circumstances and aims at proposing a monitoring apparatus and method capable of presenting the current status of the equipment in a manner easily comprehensible manner for a user(s).

### Means to Solve the Problems

In order to solve the above-described problems, there is provided according to the present invention a monitoring apparatus for monitoring equipment which is a monitoring object, wherein the monitoring apparatus includes: an input unit that accepts designation of equipment identifying information for identifying object equipment that is the equipment which is an analysis object, and an analysis item to be analyzed regarding the object equipment; an equipment status decision unit that acquires data of a data type which is required to analyze the analysis item accepted by the input unit and decides a current equipment status or statuses of the object equipment based on the acquired data; a diagnosis result decision unit that calculates a diagnosis score for evaluating a current status of the object equipment as a score based on the equipment status of the object equipment as decided by the equipment status decision unit, and decides a diagnosis result of the object equipment on the basis of the calculated diagnosis score; and a visualization unit that visualizes the diagnosis result of the object equipment decided by the diagnosis result decision unit.

Also, there is provided according to the present invention a monitoring method executed by a monitoring apparatus for monitoring equipment which is a monitoring object, wherein the monitoring method includes: a first step of accepting designation of equipment identifying information for identifying object equipment that is the equipment which is an analysis object, and an analysis item to be analyzed regarding the object equipment; a second step of acquiring data of a data type which is required to analyze the accepted analysis item and deciding a current equipment status or statuses of the object equipment based on the acquired data; a third step of calculating a diagnosis score for evaluating a current status of the object equipment as a score based on the decided equipment status of the object equipment, and deciding a diagnosis result of the object equipment on the basis of the calculated diagnosis score; and a fourth step of visualizing the decided diagnosis result of the object equipment.

If the analysis apparatus and method according to the present invention is employed, it is possible to visualize the current status of the object equipment as the diagnosis score and present it to the user(s).

### Advantageous Effects of the Invention

The monitoring apparatus and method capable of presenting the current status of the equipment to the user in an easily comprehensible manner can be implemented according to the present invention.

### BRIEF DESCRIPTION OF DRAWINGS

FIG. 1 is a block diagram illustrating an overall configuration of a monitoring system according to this embodiment;

FIG. 2 is a block diagram illustrating the configuration of an analysis server;

FIG. 3 is a chart illustrating a configuration example of an equipment identifying information database;

FIG. 4 is a chart illustrating a configuration example of an analysis item database;

FIG. 5 is a block diagram illustrating a configuration example of an equipment information database;

FIG. 6 is a chart illustrating a structure example of an alarm/failure information management table;

FIG. 7 is a chart illustrating a structure example of an operation data management table;

FIG. 8 is a chart illustrating a configuration example of a status and class management database;

FIG. 9 is a chart illustrating a configuration example of a past history information database;

FIG. 10 is a chart illustrating a structure example of a diagnosis result table;

FIG. 11 is a block diagram for explaining the respective programs mounted in the analysis server;

FIG. 12 is a chart illustrating an output example of a ranking processing unit;

FIG. 13 is a chart illustrating a variation of an output example of the ranking processing unit;

FIG. 14 is a diagram illustrating a screen configuration example of an analysis result display screen;

FIG. 15 is a diagram for explaining an equipment search screen;

FIG. 16 is a diagram for explaining the equipment search screen;

FIG. 17 is a flowchart illustrating a processing sequence for equipment status diagnosis processing;

FIG. 18 is a flowchart illustrating a processing sequence for equipment status decision processing;

FIG. 19 is a flowchart illustrating a processing sequence for past history comparison processing; and

FIG. 20 is a chart for explaining equipment status diagnosis processing.

### DESCRIPTION OF EMBODIMENTS

An embodiment of the present invention will be described below in detail with reference to the drawings.

### (1) Configuration of Monitoring System According to this Embodiment

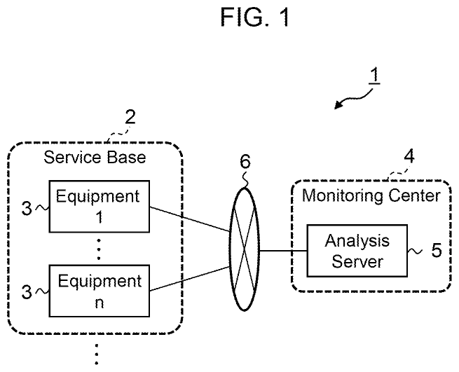

Referring to FIG. 1, 1 represents a monitoring system according to this embodiment as a whole. This monitoring system 1 is a system for monitoring the status(es) of equipment which is a plurality of monitoring objects such as air compressors and is configured by connecting equipment 3 which is one or a plurality of monitoring objects installed respectively at one or a plurality of service bases 2 such as plants, and an analysis server 5 installed at a monitoring center 4 via a network 6 such as the Internet.

Each equipment 3 regularly or irregularly transmits information such as an internal equipment temperature, an internal equipment pressure, an ambient temperature, and operating time accumulated until then, as operation data, to the analysis server 5 via the network 6. Moreover, for example, if some kind of measured value becomes equal to or larger than a threshold value, if a failure has occurred, and if a repair or an inspection is performed, the equipment 3 transmits an alarm or notice according to its content to the analysis server 5 via the network 6.

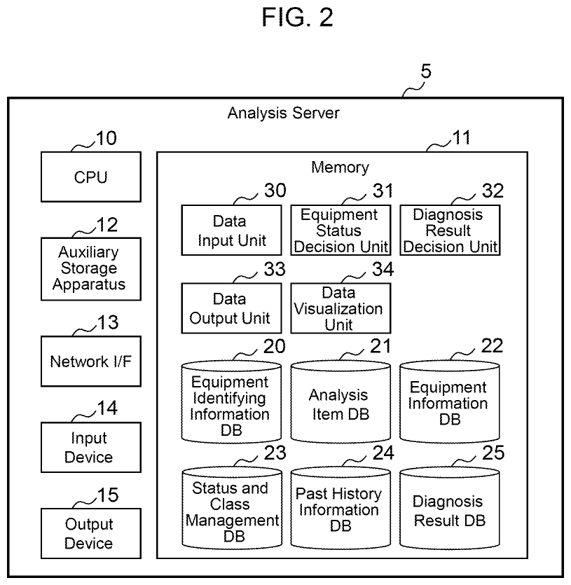

The analysis server 5: is a server apparatus having a function that monitors an equipment status of each equipment 3; and is configured by including, as illustrated in FIG. 2, a CPU (Central Processing Unit) 10, a memory 11, an auxiliary storage apparatus 12, a network interface 13, an input device 14, and an output device 15.

The CPU 10 is a processor for controlling operations of the analysis server 5 in an integrated manner. Furthermore, the memory 11 is configured from a ROM(s) (Read Only Memory) which is composed of a nonvolatile storage element(s) and is not illustrated in the drawing, and a RAM(s) (Random Access Memory) which is composed of a volatile storage element(s) and is not illustrated in the drawing. The ROM stores unchangeable programs such as a BIOS (Basic Input Output System). Also, the RAM is configured from, for example, a DRAM (Dynamic RAM) and is used as a working memory for the CPU 10.

The auxiliary storage apparatus 12 is configured from a large-capacity and nonvolatile storage apparatus(es) such as a hard disk drive(s) and an SSD(s) (Solid State Drive(s)). The auxiliary storage apparatus 12 stores various kinds of programs and various kinds of data to be stored for a long period of time. The programs and data stored in the auxiliary storage apparatus 12 are loaded from the auxiliary storage apparatus 12 to the memory 11 when activating the analysis server or whenever necessary; and various kinds of processing described later of the analysis server 5 as a whole is executed by the CPU by executing the programs which are loaded to the memory 11.

The network interface 13 is configured from, for example, an NIC (Network Interface Card) and functions as an interface when communicating with each equipment 3, which is the monitoring object, via the network 6 (FIG. 1).

The input device 14 is configured from, for example, a mouse and a keyboard and is used by a user to input various kinds of operations to the analysis server 5. Moreover, the output device 15 is configured from, for example, a liquid crystal panel, an organic EL (Electro-Luminescence) display, and/or a printer and is used to output necessary information by displaying or printing it. Incidentally, the input device 14 and the output device 15 may be configured from, for example, a touch panel in which these devices are integrated with each other.

### (2) Equipment Analysis Function According to this Embodiment

Next, an explanation will be provided about an equipment analysis function mounted in the analysis server 5. When the user gives an analysis execution instruction to designate equipment 3 which should be an analysis object (hereinafter referred to as “object equipment”) and an analysis item(s), this equipment analysis function is a function that executes analysis processing on the analysis item(s) with respect to the object equipment 3 and visualizes and presents the analysis results to the user. In the case of this embodiment, such “analysis item(s)” includes, for example, an “Equipment Status Diagnosis” for diagnosing a current equipment status of the object equipment 3 and “Maintenance Timing” to diagnose the next maintenance timing.

Practically, when the above-described analysis execution instruction is given, the analysis server 5 identifies the designated object equipment 3 and data types of all the data required to analyze the designated analysis items (hereinafter referred to as “necessary data types” as appropriate), respectively, and acquires data of each identified necessary data type from a database described later and stored in the memory 11.

Then, the analysis server 5 executes the analysis processing according to the analysis items such as the “Equipment Status Diagnosis” and the “Maintenance Timing” which are designated by the user on the basis of the acquired data. Incidentally, in the following description, an explanation will be provided about the case where the analysis item designated by the user is the “Equipment Status Diagnosis.”

In the above-described analysis processing, the analysis server 5 firstly detects various kinds of anomaly states, which have occurred or are occurring at the object equipment 3, on the basis of data of each necessary data type acquired as described above. Examples of such anomaly states include, for example: “Long-Term Suspension” where the equipment is in a long-term suspended state due to maintenance or the like; “Equipment Temperature: High” where the temperature inside the equipment is higher than an upper limit threshold value; “Equipment Temperature: Low” where the temperature inside the equipment is lower than a lower limit threshold value; “Internal Equipment Pressure: High” where the pressure inside the equipment is higher than an upper limit threshold value; “Internal Equipment Pressure: Low” where the pressure inside the equipment is lower than a lower limit threshold value; and “Alarm/Failure Occurrence” where an alarm was issued or a failure occurred in the past. The analysis server 5 detects all the anomaly states, which the current object equipment 3 falls under, as the equipment status of the object equipment 3 from among these anomaly states.

Subsequently, the analysis server 5 sorts each equipment status of the object equipment 3, which is detected as described above, to the corresponding diagnosis class (i.e., the diagnosis class corresponding to the cause of the occurrence of the relevant equipment status) among four classes, that is, an “Operational Method,” an “Installation Environment,” an “Inspection Defect,” and “Component Consumption” (these classes will be hereinafter referred to as “diagnosis classes”) which are associated with four major causes of the anomaly states, that is, the “Operational Method,” the “Installation Environment,” the “Inspection Defect,” and the “Component Consumption.”

Furthermore, the analysis server 5 calculates a total score of each diagnosis class by multiplying the number of the equipment statuses of the object equipment 3 sorted to the relevant diagnosis class by a score which is set to the relevant diagnosis class in advance; and further calculates a total value of the total scores of the respective diagnosis classes as a diagnosis score which represents the current equipment status of the object equipment 3.

In this case, the score of each diagnosis class is set according to the seriousness of the equipment status (anomaly state) sorted to the relevant class so that the score of each diagnosis class becomes larger as the above-described equipment status is in a more serious state. Accordingly, the diagnosis score of the object equipment 3 calculated as described above becomes a larger value when the current status of the relevant object equipment 3 is much worse. In other words, it can be said that the above-described diagnosis score is an index representing the degree of badness of the current status of the object equipment 3.

Subsequently, the analysis server 5 ranks the degree of badness of the status of the relevant object equipment 3 among all the equipment in a certain classification group on the basis of the diagnosis score of the object equipment which was calculated as described above. In the case of this embodiment, the following three classification groups are defined in advance as the above-described classification group: a classification group formed of an equipment group of the same model; a classification group formed of a group of equipment existing in the same area (for example, the same prefecture); and a classification group formed of a group of equipment having about the same amount of accumulated operating time. The analysis server 5 ranks the degree of badness of the status of the object equipment 3, among all the equipment 3 in the relevant classification group with respect to each of these classification groups. However, other classification groups may be defined as the classification groups instead of or in addition to these classification groups.

Furthermore, the analysis server 5 diagnoses some items which are predefined or designated by the user, such as the “Internal Equipment Temperature,” “Alarm/Failure Count,” and “Clogging State of Filter” (hereinafter referred to as “diagnosis items”), with respect to the object equipment on the basis of data of each necessary data item acquired as described earlier.

Then, the analysis server 5: visualizes, as texts and graphs, the ranking results of each classification group and the diagnosis results with respect to each diagnosis item; displays the ranking results if the output device 15 is a display; and prints out the ranking results if the output device 15 is a printer.

The following are stored, as means for implementing the above-described equipment analysis function, in the memory 11 for the analysis server 5 as illustrated in FIG. 2: as databases, an equipment identifying information database 20, an analysis item database 21, an equipment information database 22, a status and class management database 23, a past history information database 24, and a diagnosis result database 25; and, as programs, a data input unit 30, an equipment status decision unit 31, a diagnosis result decision unit 32, a data output unit 33, and a data visualization unit 34.

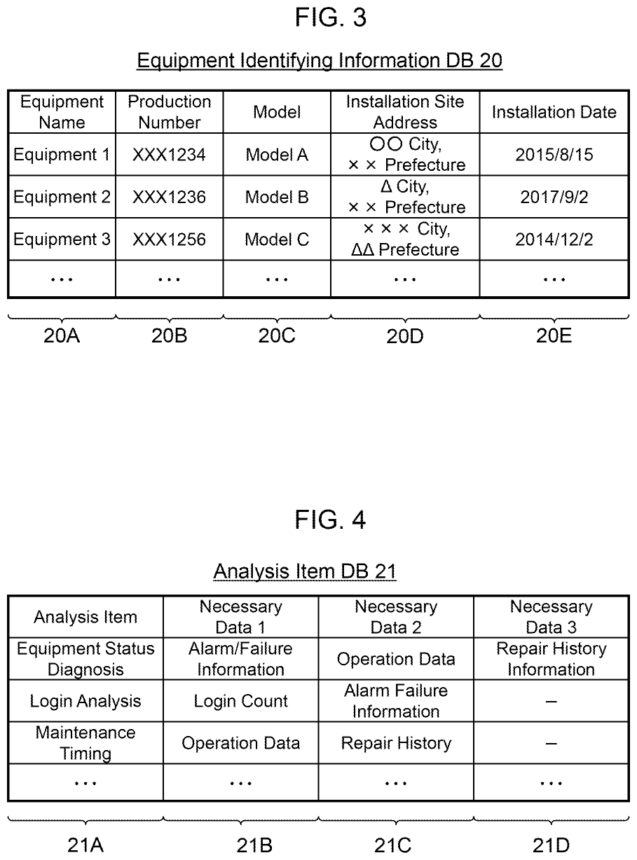

The equipment identifying information database 20: is a database in which various kinds of information regarding each equipment 3 which is a monitoring object(s) of the analysis server 5; and has a table structure including, as illustrated in FIG. 3, an equipment name column 20A, a production number column 20B, a model column 20C, an installation site address column 20D, and an installation date column 20E. In the equipment identifying information database 20 in FIG. 3, one record (row) corresponds to one piece of the monitoring object equipment 3.

Then, the equipment name column 20A stores an equipment name of the relevant equipment 3. Moreover, the production number column 20B stores a production number of that equipment 3; and the model column 20C stores a model type of that equipment 3. Furthermore, the installation site address column 20D stores the address of an installation site of that equipment 3; and the installation date column 20E stores the date when that equipment 3 was installed at that address.

Accordingly, in the case of the example in FIG. 3, for example, it is shown that the equipment 3 which has the equipment name “Equipment 1,” to which the production number “XXX1234” is assigned, and which is of the model type called “Model A” was installed in “∘∘ City, xx Prefecture” on “2015/8/15.”

The analysis item database 21: is a table in which the necessary data type for each analysis item is defined to indicate what kind of data of which data type is required when executing the analysis processing on the analysis item(s) designated by the user; and has a table structure including, as illustrated in FIG. 4, an analysis item column 21A and a plurality of necessary data type columns 21B. In the analysis item database 21 in FIG. 4, one record (row) corresponds to one analysis item.

Then, the analysis item column 21A stores an item name of an analysis item which can be designated by the user; and each necessary data type column 21B stores one necessary data type of data required to perform the analysis processing on each relevant analysis item. The necessary data type columns 21B of each record are used as many as the number of the necessary data types required to execute the analysis processing on the analysis items corresponding to that record.

Accordingly, in the case of the example in FIG. 4, for example, it is shown that when the user designates certain equipment 3 and gives the instruction to analyze the analysis item, that is, the “Equipment Status Diagnosis” regarding that equipment 3, three kinds of data types, that is, “Alarm/Failure Information,” “Operation Data,” and “Repair History Information” regarding the relevant equipment 3 are the necessary data types to perform the analysis.

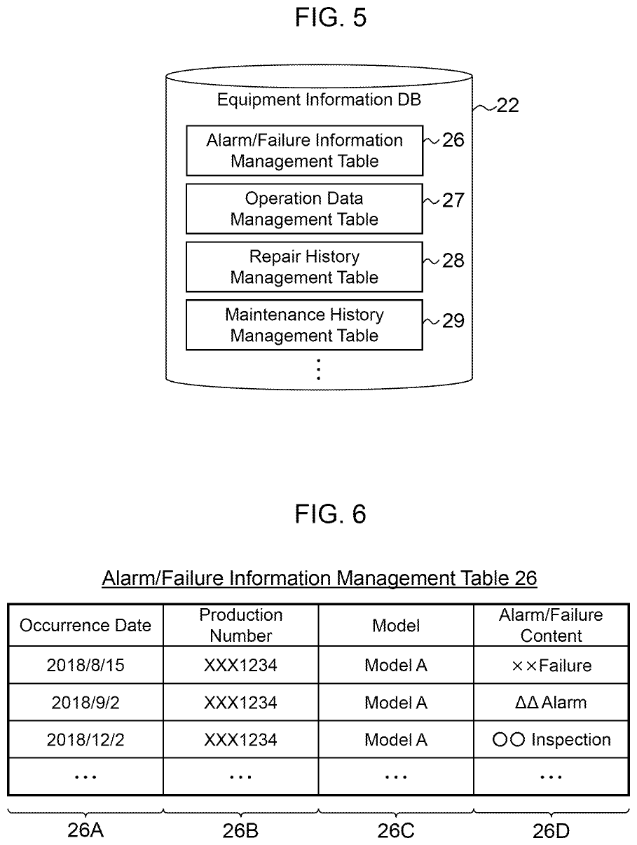

The equipment information database 22: is a database used to store and retain various kinds of information acquired by the analysis server 5 from each equipment 3 and various kinds of information regarding each equipment 3; and is configured from various kinds of tables such as, as illustrated in FIG. 5, an alarm/failure information management table 26, an operation data management table 27, a repair history management table 28, and a maintenance history management table 29.

Of these tables mentioned above, the alarm/failure information management table 26: is a table used to manage alarms given from each equipment 3, which is the monitoring object, and notices of a failure(s) (hereinafter referred to as a “failure notice(s)”); and is configured by including, as illustrated in FIG. 6, an occurrence date and time column 26A, a production number column 26B, a model column 26C, and an alarm/failure content column 26D. In the alarm/failure information management table 26 in FIG. 6, one record (row) corresponds to the alarm or failure notice received by the analysis server 5 in one reception.

Then, the occurrence date and time column 26A stores the date when the relevant alarm or failure notice was received by the analysis server 5; and the production number column 26B stores the production number of the equipment 3 which transmitted the relevant alarm or the failure notice. Moreover, the model column 26C stores the model type of the relevant equipment 3; and the alarm/failure content column 26D stores the specific content of the relevant alarm or the failure notice.

Accordingly, in the case of the example in FIG. 6, for example, it is shown that the notice indicating “xx failure (xx is a failure)” was transmitted from the equipment 3 with the production number “XXX1234” and of the model type called “Model A.”

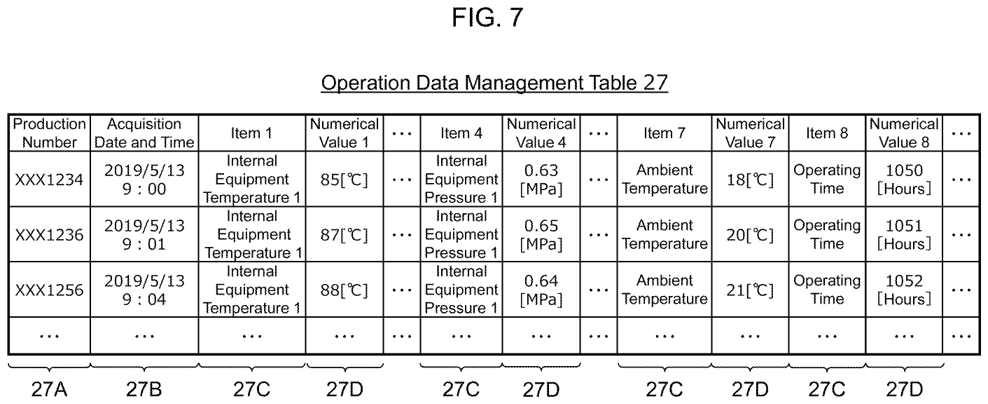

Furthermore, the operation data management table 27: is a table used to manage the operation data which indicates the operating status of the equipment 3 and is regularly or irregularly transmitted from each equipment 3; and is configured by including, as illustrated in FIG. 7, a production number column 27A and an acquisition date and time column 27B, and a plurality of sets of item columns 27C and numerical value columns 27D. In the operation data management table 27 in FIG. 7, one record (row) corresponds to the operation data transmitted from one equipment 3 in one transmission.

Then, the production number column 27A stores the production number of the equipment 3 which transmitted the relevant operation data; and the acquisition date and time column 27B stores the date and time when that operation data was acquired. Moreover, each item column 27C stores the type of the relevant information such as the “Internal Equipment Temperature,” “Internal Equipment Pressure,” “Ambient Temperature,” or “Operating Time”; and the numerical value column 27D which forms a pair with the relevant item column 27C stores a measured value or an actual result value of the information of the relevant type.

Accordingly, in the case of the example in FIG. 7, for example, it is shown that regarding the operation data transmitted from the equipment 3 with the production number “XXX1234” at “2019/5/13 9:00,” “Internal Equipment Temperature 1” of that equipment 3 was “85[° C.],” its “Internal Equipment Pressure 1” was “0.63 [MPa],” its “Ambient Temperature” was “18[° C.],” the accumulated “Operating Time” was “1050 [hours].” Incidentally, the internal equipment temperature and the internal equipment pressure of each equipment 3 were measured at a plurality of locations and “Internal Equipment Temperature 1” and “Internal Equipment Pressure 1” mean that they are data indicating the internal equipment temperature and the internal equipment pressure at one of such locations.

The repair history management table 28 is a table used to manage information of a repair history (repair history information) of each equipment 3; and the maintenance history management table 29 is a table used to manage information of a maintenance history (maintenance history information) of each equipment 3. An explanation about the specific details of these repair history management table 28 and maintenance history management table 29 is omitted.

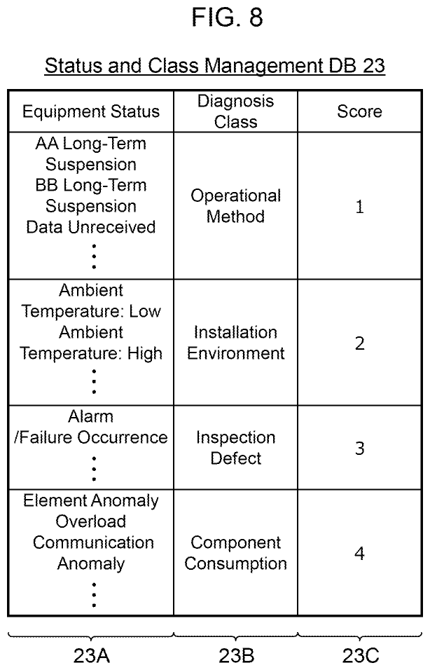

The status and class management database 23: is a database used to manage the correspondence relationship between diagnosis classes, representative equipment statuses belonging to these diagnosis classes, and preset scores for each diagnosis class; and has a table structure including, as illustrated in FIG. 8, an equipment status column 23A, a diagnosis class column 23B, and a score column 23C. In the status and class management database 23 in FIG. 8, one record (row) corresponds to one diagnosis class.

Then, the diagnosis class column 23B stores the name of the relevant diagnosis class (an “Operational Method,” an “Installation Environment,” an “Inspection Defect,” or “Component Consumption”); and the equipment status column 23A stores some representative equipment statuses (anomaly states) belonging to the relevant diagnosis class. Moreover, the score column 23C stores a preset score for the relevant diagnosis class. In the case of this embodiment, a higher score is set to the diagnosis class corresponding to the cause which causes a more serious equipment status (anomaly state) as described earlier.

Accordingly, in the case of the example in FIG. 8, it is shown that the equipment statuses (anomaly states) such as “AA Long-Term Suspension,” “BB Long-Term Suspension,” and “Data Unreceived” belong to the diagnosis class called the “Operational Method” and the score “1 point” is set to this diagnosis class called the “Operational Method.”

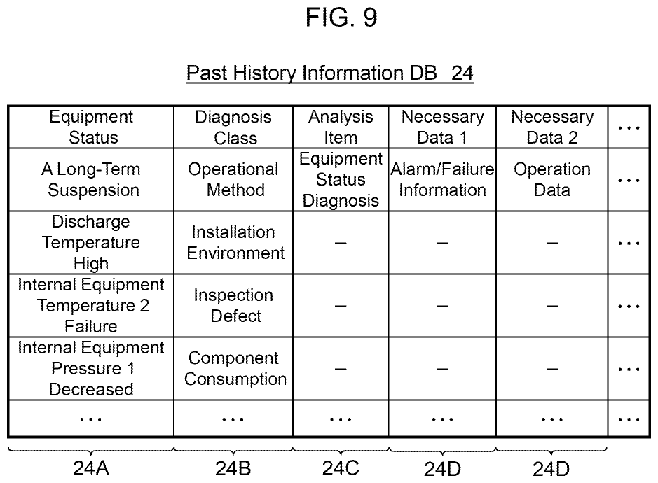

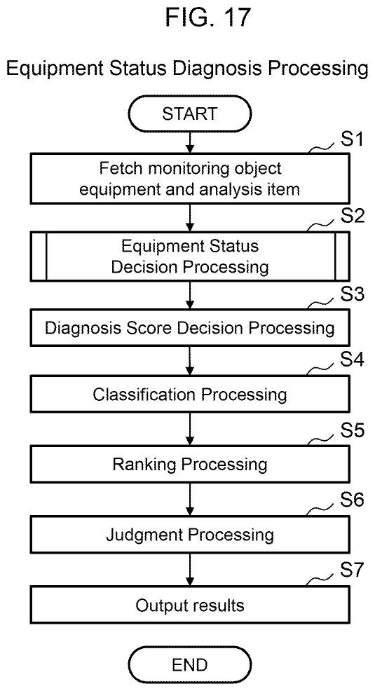

The past history information database 24 is a database used by the equipment status decision unit 31B described later to manage the correspondence relationship between the equipment statuses and the diagnosis classes which have not been registered in the status and class management database 23 (FIG. 8) and which are associated with each other by equipment status decision processing which has been executed by then and which will be described later with reference to FIG. 17. The past history information database 24 is configured by including, as illustrated in FIG. 9, an equipment status column 24A, a diagnosis class column 24B, an analysis item column 24C, and a plurality of necessary data type columns 24D.

Then, the equipment status column 24A stores the equipment statuses among the equipment statuses and the diagnosis classes which are associated by the equipment status decision processing executed in the past; and the diagnosis class column 24B stores the diagnosis classes among the above-described equipment statuses and the diagnosis classes. Moreover, the analysis item column 24C stores an analysis item which was then designated by the user; and each necessary data type column 24D stores the data type of data required to execute the analysis of that analysis item (necessary data type).

Accordingly, in the case of the example in FIG. 9, it is shown that the equipment status called “A Long-Term Suspension” is associated with the diagnosis class called the “Operational Method” by the equipment status decision processing executed in the past. Moreover, FIG. 9 shows that the association was made when the analysis of the analysis item called the “Equipment Status Diagnosis” was performed and data of the data types called the “Alarm/Failure Information” and the “Operation Data” were respectively necessary to detect the equipment status called “A Long-Term Suspension.”

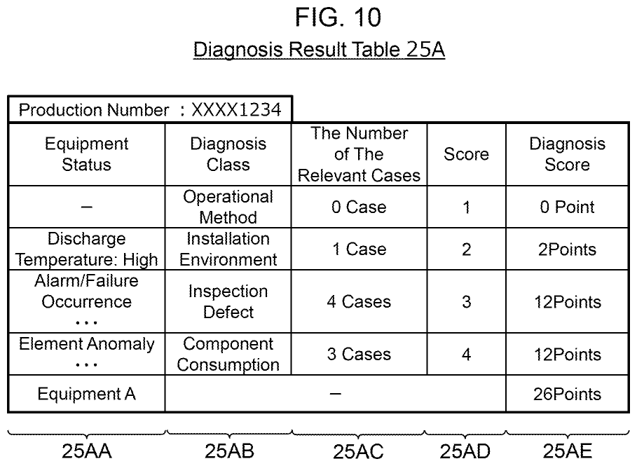

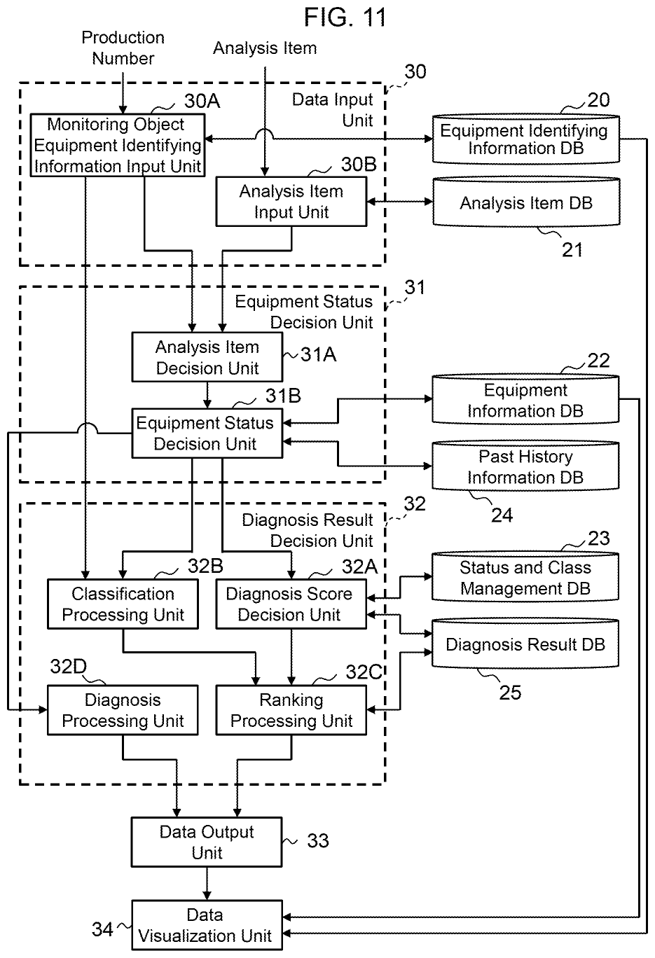

The diagnosis result database 25 is a table used to accumulate and manage the diagnosis scores calculated respectively for the respective equipment 3. In this explanation, the analysis item is explained as the “Equipment Status Diagnosis.” Therefore, every time the “Equipment Status Diagnosis” is performed for one equipment 3, one diagnosis result table 25A as illustrated in FIG. 10 is created, is associated with the production number of the relevant equipment 3, and is stored in the diagnosis result database 25.

This diagnosis result table 25A is configured by including, as illustrated in FIG. 10, an equipment status column 25AA, a diagnosis class column 25AB, a relevant-number-of-cases column 25AC, a score column 25AD, and a diagnosis score column 25AE.

Then, the diagnosis class column 25AB stores the name of each diagnosis class (the “Operational Method,” the “Installation Environment,” the “Inspection Defect,” and the “Component Consumption”). Moreover, the equipment status column 25AA stores all the equipment statuses belonging to the relevant diagnosis class, from among the respective equipment statuses of the object equipment 3 which are detected by the analysis.

Furthermore, the relevant-number-of-cases column 25AC stores the number of the equipment statuses belonging to the relevant diagnosis class detected with regard to the object equipment 3; and the score column 25AD stores the score which is set regarding the relevant diagnosis class. Furthermore, the diagnosis score column 25AE stores the diagnosis score regarding the relevant diagnosis class which is calculated by multiplying the number of the equipment statuses belonging to the relevant diagnosis class by the score of the relevant diagnosis class. Incidentally, the diagnosis score column 25AE at the bottom row of the diagnosis result table 25A stores the diagnosis score of the object equipment 3 which is calculated by adding up the diagnosis scores of the respective diagnosis classes and which indicates the degree of badness of the status of the object equipment 3.

Accordingly, in the case of the example in FIG. 10, it is shown that: in the equipment status diagnosis of the object equipment 3 with the production number “XXXI 234,” the equipment status belonging to the diagnosis class called the “Operational Method” is not detected; and “1 case” of the equipment status called an “Ambient Temperature: Low” belonging to the diagnosis class called the “Installation Environment,” “4 cases” of the equipment statuses including “Alarm/Failure Occurrence” as the equipment statuses belonging to the diagnosis class called the “Inspection Defect,” and a total of “3 cases” of the equipment statuses including “Element Anomaly” as the equipment statuses belonging to the diagnosis class called the “Component Consumption” were detected, respectively.

Furthermore, FIG. 10 shows that as the results of the above, the diagnosis score of the diagnosis class called the “Operational Method” is “0 point,” the diagnosis score of the diagnosis class called the “Installation Environment” is “2 points,” the diagnosis score of the diagnosis class called the “Inspection Defect” is “12 points,” the diagnosis score of the diagnosis class called the “Component Consumption” is “12 points,” and the diagnosis score of the object equipment 3 is “26 points.”

Meanwhile, the data input unit 30 (FIG. 2) is a program having a function that accepts equipment specifying information (the production number in this example) for identifying the object equipment 3, and the analysis item(s) which are input by the user, acquires necessary information from the equipment identifying information database 20 (FIG. 3) and the analysis item database 21 (FIG. 4) on the basis of the accepted production number and analysis item(s), and notifies the equipment status decision unit 31 (FIG. 2) of the acquired necessary information. This data input unit 30 is configured as a functional unit by including, as illustrated in FIG. 11, a monitoring object equipment identifying information input unit 30A and an analysis item input unit 30B.

The monitoring object equipment identifying information input unit 30A: searches the respective records (rows) of the equipment identifying information database 20 (FIG. 3) for a record in which the production number designated by the user is stored in the production number column 20B; reads the equipment name, the model, the installation site address, and the installation date of the object equipment 3, which are stored respectively in the equipment name column 20A, the model column 20C, the installation site address column 20D, and the installation date column 20E, which are described earlier with reference to FIG. 3, of the record detected by this search from the equipment identifying information database 20; and notifies the equipment status decision unit 31 and the diagnosis result decision unit 32 of the read information.

For example, in the example in FIG. 3, when the production number of the object equipment designated by the user is “XXX1234,” the respective pieces of information such as “Equipment 1” as the equipment name, “Model A” as the model type, “∘∘ City, xx Prefecture” as the installation site address, and “2015/8/15” as the installation date are respectively read from the equipment identifying information database 20 by the search and these pieces of information are respectively reported to the equipment status decision unit 31 and the diagnosis result decision unit 32.

Moreover, the analysis item input unit 30B: searches the records of the analysis item database 21 (FIG. 4) for a record in which the analysis item(s) designated by the user is stored in the analysis item column 21A (FIG. 4); reads all the data types respectively stored in the respective necessary data type columns 21B (FIG. 4) of the record found by this search from the analysis item database 21; and reports these data types and the analysis item(s) designated by the user to the equipment status decision unit 31.

For example, in the example in FIG. 4, if the analysis item designated by the user is the “Equipment Status Diagnosis,” the respective pieces of information such as the “Alarm/Failure Information,” the “Operation Data,” and the “Repair History Information” are read as the necessary data types of the data from the analysis item database 21 as the results of the above-described search and these pieces of information are reported to the equipment status decision unit 31.

The equipment status decision unit 31 is a program having a function that decides the status of the object equipment 3 on the basis of the equipment name, the model, the installation site address, and the installation date of the object equipment 3 which are reported from the monitoring object equipment identifying information input unit 30A for the data input unit 30, and the analysis item(s) designated by the user and the necessary data type(s) of each data to execute the analysis of such analysis item(s) which are reported from the analysis item input unit 30B. This equipment status decision unit 31 is configured as a functional unit by including an analysis item decision unit 31A and an equipment status decision unit 31B.

The analysis item decision unit 31A decides the analysis item, which was designated by the user and reported from the analysis item input unit 30B for the data input unit 30, as an analysis item to be executed then. Then, the analysis item decision unit 31A notifies the equipment status decision unit 31B of the decided analysis item, the necessary data types of each data to perform the analysis of the analysis item reported from the analysis item input unit 30B (the necessary data type), and the production number of the object equipment 3 reported from the monitoring object equipment identifying information input unit 30A.

Accordingly, in the aforementioned example, the analysis item decision unit 31A decides the “Equipment Status Diagnosis” as the analysis item and reports the decision result to the equipment status decision unit 31B, and also notifies the equipment status decision unit 31B that the necessary data types of the data for the analysis of that analysis item (the necessary data types) are the “Alarm/Failure Information,” the “Operation Data,” and the “Repair History Information.”

The equipment status decision unit 31B searches the relevant management table within the equipment information database 22 for the data related to the object equipment 3 by using, as a search key, the equipment number reported from the analysis item decision unit 31A and acquires each data detected by this search. Moreover, the equipment status decision unit 31B decides the respective equipment statuses of the object equipment 3 and the diagnosis classes to which these equipment statuses belong, respectively, on the basis of each of the acquired data, and reports the respective decided equipment statuses and diagnosis classes of the object equipment 3 to the diagnosis result decision unit 32. Furthermore, the equipment status decision unit 31B reads the accumulated operating time of the object equipment 3 from the operation data management table 27 (FIG. 7) and reports it to the diagnosis result decision unit 32, also reports the data related to the object equipment 3, which is acquired as described above from the equipment information database 22, to the diagnosis result decision unit 32.

Accordingly, in the aforementioned example, the equipment status decision unit 31B searches the alarm/failure information management table 26 (FIG. 6), in which the “Alarm/Failure Information” is stored, for the data related to the object equipment 3 (the equipment 3 with the production number “XXX1234”), also searches the operation data management table 27 (FIG. 7), in which the “Operation Data” is stored, for the data related to the object equipment 3, and further searches the repair history management table 28 (FIG. 5), in which the “Repair History Information” is stored, for the data related to the object equipment 3. Moreover, the equipment status decision unit 31B decides the respective equipment statuses of the object equipment 3 and the diagnosis classes to which these equipment statuses respectively belong, on the basis of the data detected by these searches, and reports the decided results to the diagnosis result decision unit 32. Incidentally, more specific processing content of the equipment status decision unit 31 will be described later.

The diagnosis result decision unit 32 is a program having a function that evaluates the current equipment status of the object equipment 3 as a score and ranks the object equipment 3 in the respective classification groups (the respective classification groups in this example are the “Model,” the “Area,” and the “Operating Time”). This diagnosis result decision unit 32 is configured as a functional unit by including a diagnosis score decision unit 32A, a classification processing unit 32B, a ranking processing unit 32C, and a diagnosis processing unit 32D.

The diagnosis score decision unit 32A evaluates the current status of the object equipment 3 as a score on the basis of the respective equipment statuses of the object equipment 3 and the diagnosis classes for these respective equipment statuses, which are reported from the equipment status decision unit 31B, with reference to the status and class management database 23 (FIG. 8) and the past history information database 24 (FIG. 9).

Practically, the diagnosis score decision unit 32A counts the number of the equipment statuses of the object equipment 3 belonging to the relevant diagnosis class with respect to each diagnosis class and calculates the diagnosis score of each diagnosis class by multiplying the count result by a preset score for the relevant diagnosis class. Moreover, the diagnosis score decision unit 32A evaluates the current equipment status of the object equipment 3 as a score by adding up the diagnosis scores for the respective diagnosis classes which are calculated as described above. Then, the diagnosis score decision unit 32A reports the diagnosis scores for the respective diagnosis classes, which are calculated as described above, and the diagnosis score of the object equipment 3, which is a total value of these diagnosis scores for the respective diagnosis classes, to the ranking processing unit 32C and records them in the diagnosis result table 25A, which was described earlier with reference to FIG. 10, and stores them in the diagnosis result database 25.

The classification processing unit 32B judges to which classification group the object equipment 3 belongs with respect to the “Model,” the installment site “Area,” and the accumulated “Operating Time,” respectively, on the basis of the model and the installation site address of the object equipment 3 reported from the monitoring object equipment identifying information input unit 30A for the data input unit 30 and the accumulated operating time of the object equipment 3 reported from the equipment status decision unit 31B for the equipment status decision unit 31.

Practically, regarding the “Model,” the classification processing unit 32B judges the classification group for the model to which the relevant object equipment 3 belongs, based on the model of the object equipment 3 reported from the monitoring object equipment identifying information input unit 30A. Moreover, regarding the installment site “Area,” the classification processing unit 32B judges the classification group for the area to which the installation site of the relevant object equipment 3 belongs, based on the installation site address of the object equipment 3 reported from the monitoring object equipment identifying information input unit 30A. Furthermore, regarding the accumulated “Operating Time,” the classification processing unit 32B judges to which classification group, among some classification groups of the operating time such as “0 to 100 hours,” “100 to 500 hours,” and “500 to 1000 hours,” the operating time reported from the equipment status decision unit 31B belongs.

Then, the classification processing unit 32B reports each classification group of the “Model,” the installment site “Area,” and the accumulated “Operating Time” of the object equipment, which is judged as described above, to the ranking processing unit 32C.

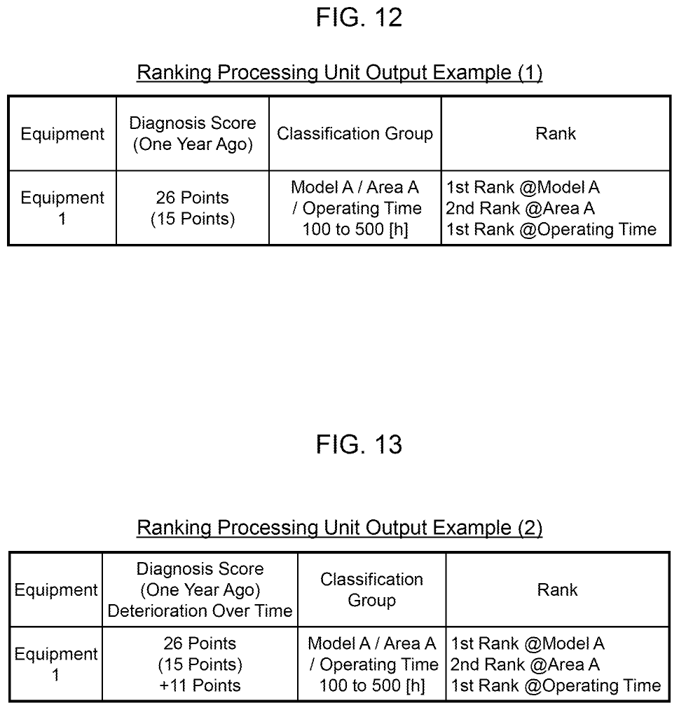

The ranking processing unit 32C ranks the degree of badness of the current status of the object equipment 3 by indicating in which rank the current status of the object equipment 3 is positioned within the relevant classification group with respect to each of the classification groups of the “Model,” “Area,” and the “Operating Time” on the basis of the diagnosis results of the object equipment 3 reported from the diagnosis score decision unit 32A and other diagnosis results (diagnosis scores) of the monitoring object equipment 3 registered in the diagnosis result database 25. Such ranking can be performed by sorting the respective pieces of the equipment 3 belonging to the relevant classification group by the size of the diagnosis score with respect to each classification group and sequentially assigning the ranks in descending order of the diagnosis score. Then, the ranking processing unit 32C outputs such ranking results in a format, for example, as illustrated in FIG. 12, to the data output unit 33. Moreover, along with this, the ranking processing unit 32C reads its own score in the past (for example, six months ago or one year ago), which is stored in the diagnosis result database 25, and outputs its own past diagnosis score which has been read, together with the above-described ranking results, to the data output unit 33.

Incidentally, FIG. 12 shows that: the diagnosis score of the equipment called “Equipment 1” was “15 points” one year ago and its current diagnosis score is “26 points”; such equipment is classified into a classification group whose model, the installation site area, and the operating time are “Model 1,” “Area A,” and “100 to 500 [h]”; and the degree of badness of the status is positioned in the “1st rank” among the equipment 3 of the same model, the degree of badness of the status is positioned in the “2nd rank” among the equipment 3 installed in the same area, and the degree of badness of the status is positioned in the “1st rank” among the equipment 3 with the same operating time “100 to 500 [h].”

However, for example, as illustrated in FIG. 13, the ranking processing unit 32C may calculate the difference between the diagnosis score of the object equipment 3 calculated this time and the diagnosis score of the object equipment 3 one year ago (or several months or several years ago) as deterioration over time, that is, the degree of deterioration over time of the object equipment 3 as compared to one year ago (or several months or several years ago) on the basis of the diagnosis score of the object equipment 3 one year ago which is stored in the diagnosis result database 25; and may rank the object equipment 3 within each classification group on the basis of the calculated deterioration over time. In this case, the ranks of the object equipment 3 within the relevant classification group may be calculated by sorting the equipment 3 within each classification group by the size of the deterioration over time and sequentially assigning the ranks in descending order of the deterioration over time.

The diagnosis processing unit 32D executes diagnosis processing on some diagnosis items such as an “Equipment Temperature,” the “Number of Alarm/Failure Occurrences,” and a “Clogging State” which are determined in advance, on the basis of the data of the object equipment which are reported from the equipment status decision unit 31B for the equipment status decision unit 31 and are acquired from the equipment information database 22 (FIG. 5). Specific content of such diagnosis processing by the diagnosis processing unit 32D will be described later. The diagnosis processing unit 32D reports the processing results of such diagnosis processing to the data output unit 33.

The data output unit 33 outputs the ranking results of the object equipment 3 reported from the ranking processing unit 32C and the diagnosis results regarding each diagnosis item, which are reported from the diagnosis processing unit 32D, in a form such as texts, to the data visualization unit 34. Moreover, the data visualization unit 34 visualizes the ranking processing results of the ranking processing unit 32C and the diagnosis processing results of the diagnosis processing unit 32D, which are given from the data output unit 33, in a form such as a report or a graph in a specified format and presents (displays or prints) them.

Incidentally, the data visualization unit 34 can also search the equipment identifying information database 20 (FIG. 3) and the equipment information database 22 (FIG. 5) under search conditions set by the user via the input device 14 (FIG. 2), detect the equipment 3 which satisfy the search conditions, and visualize such information.

### (3) Configurations of Various Kinds of Screens

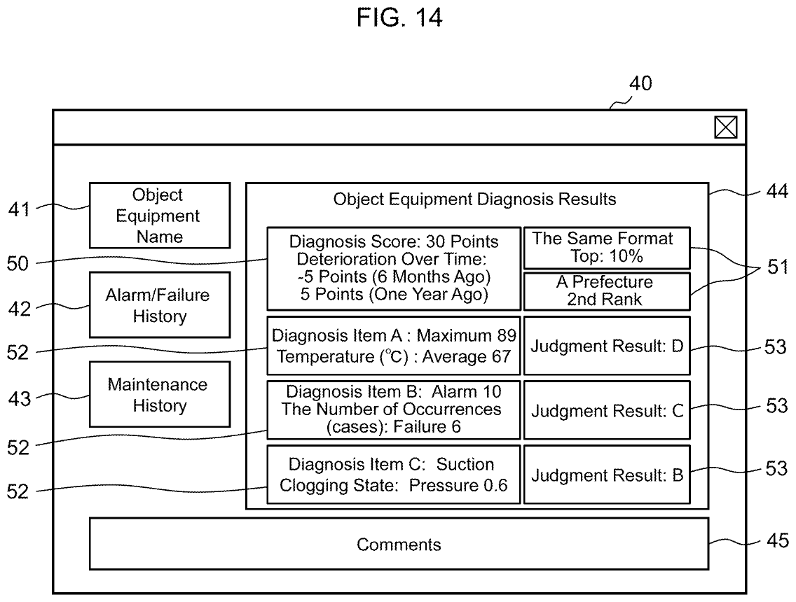

FIG. 14 illustrates a configuration example of an analysis result display screen 40 which is displayed on the output device 15 for the analysis server 5 after the termination of processing of the analysis processing (equipment status diagnosis processing in this example) based on the aforementioned equipment analysis function and/or is printed out from the output device 15. This analysis result display screen 40 is a screen for displaying the processing results of the above-described analysis processing and is configured by including an object equipment name column 41, an alarm/failure history column 42, a maintenance history column 43, a diagnosis result display field 44, and a comment column 45.

Then, the object equipment name column 41 displays the equipment name of the object equipment 3 at that time; and the alarm/failure history column 42 displays history information of alarm issuances and failure occurrences regarding the relevant object equipment 3, which is acquired from the alarm/failure information management table 26 (FIG. 6) of the equipment information database 22 (FIG. 5) in the middle of execution of the above-described analysis processing. Moreover, the maintenance history column 43 displays information of maintenance work execution history regarding the relevant object equipment 3 (maintenance history information) which is acquired from the maintenance history management table 29 (FIG. 5) in the middle of execution of the above-described analysis processing.

The diagnosis result display field 44 displays the diagnosis results of the object equipment 3 by the above-described equipment status diagnosis processing. Practically, the diagnosis result display field 44 is provided with a diagnosis score and deterioration-over-time display area 50, one or a plurality of ranking display areas 51, one or a plurality of diagnosis object display areas 52, and judgment result display areas 53 corresponding to these diagnosis object display areas 52, respectively.

Then, the diagnosis score and deterioration-over-time display area 50 displays the diagnosis score of the object equipment 3 calculated as described earlier and the deterioration over time from the statuses one year ago and six months ago. The deterioration over time is a numerical value obtained as described earlier by subtracting the diagnosis score calculated one year ago or six months ago from the latest diagnosis score of the object equipment 3. In the case of the example in FIG. 14, the deterioration over time as compared to six month ago is “−5 points,” so the status of the object equipment 3 has been improved as compared to six months ago; and on the other hand, the deterioration over time as compared to one year ago is “5 points,” so that you can tell that the status of the object equipment 3 has deteriorated as compared to one year ago.

Moreover, the ranking display area 51 displays the rank of the object equipment 3 within each classification group which is calculated as described earlier. FIG. 14 shows that the degree of badness of the status of the object equipment 3 among all the equipment 3 within “A Prefecture” as the “Area” is the “2nd Rank.” However, as illustrated in this FIG. 14, the degree of badness of the status of the object equipment 3 within the relevant classification group may be displayed as top whatever percentage instead of the rank of the object equipment 3 within the classification group. FIG. 14 shows that the degree of badness of the status of the object equipment 3 within all the equipment 3 of the classification group of the “Same Model” was “Top 10%.”

The diagnosis object display area 52 displays a diagnosis object in the relevant diagnosis item among some diagnosis items, which are judgment objects of the diagnosis processing unit 32D for the diagnosis result decision unit 32 described earlier with reference to FIG. 11, information about the diagnosis object. FIG. 14 shows that: the diagnosis object of “Diagnosis Item A” is the “Temperature”; and in relation to such “Temperature,” the maximum value of the internal equipment temperature of the object equipment 3 was “89” and an average value was “67.”

Moreover, FIG. 14 shows that: the diagnosis object of “Diagnosis Item B” is the number of alarm issuances or the number of failure occurrences (the “Number of Occurrences”); and in relation to the above-described “Number of Occurrences,” the number of alarm issuances of the object equipment 3 was “10” cases and the number of failure occurrences was “6” cases. Furthermore, FIG. 14 shows that the diagnosis object of “Diagnosis Item C” is a “Clogging State”; and, in relation to the “Clogging State,” a suction pressure of the object equipment 3 was “0.6.”

However, diagnosis items other than those mentioned above can be applied as the above-described diagnosis items. Moreover, the diagnosis item(s) can be designated by the user.

Furthermore, the judgment result display area 53 displays the judgment result judged (evaluated) in four levels from “A” to “D” by the diagnosis processing unit 32D (FIG. 11) for the diagnosis result decision unit 32 (FIG. 11) with respect to the diagnosis object displayed in the corresponding diagnosis object display area 52 (the diagnosis object display area 52 provided on the left side of that judgment result display area 53). FIG. 14 shows that the judgment result of the “Diagnosis Item A” was “D,” the judgment result of the “Diagnosis Item B” was “C,” and the judgment result of the “Diagnosis Item C” was “B.”

Incidentally, the judgment by the diagnosis processing unit 32D is performed by comparing a numerical value indicating the equipment status with the ranges respectively set to Level “A,” Level “B,” Level “C,” and Level “D.” Under this circumstance, the range of each level is set for each equipment status which is the judgment object. For example, FIG. 14 shows an example where regarding the maximum temperature for “Diagnosis Item A,” the range of Level “A” is set as “0 to 50° C.,” the range of Level “B” is set as “51 to 60° C.,” the range of Level “C” is set as “70 to 80° C.,” and the range of Level “D” is set as “81° C. or higher,” so that the equipment status of the object equipment 3 was judged as “D.”

Furthermore, the comment column 45 displays comments based on the diagnosis results of the above-described equipment status diagnosis regarding the object equipment 3.

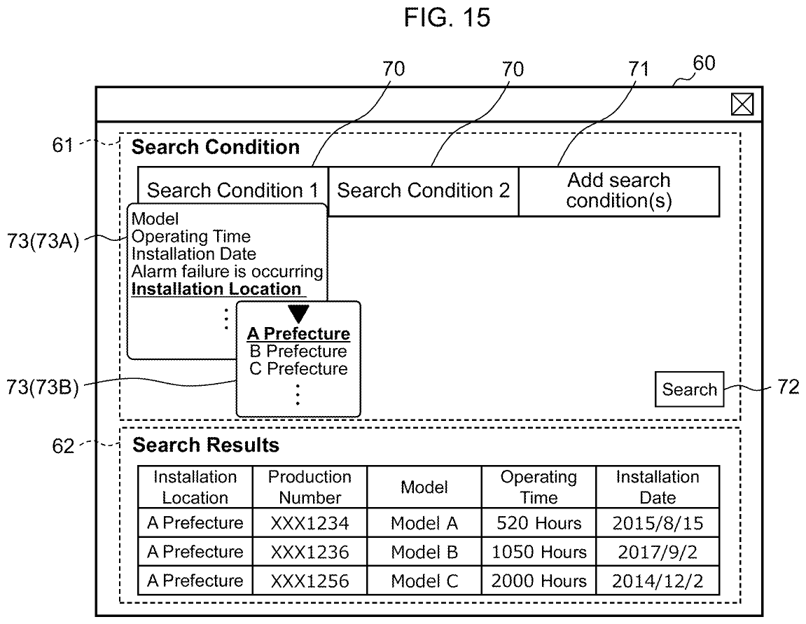

Meanwhile, FIG. 15 illustrates a configuration example of an equipment search screen 60 which can be displayed on the output device 15 for the analysis server 5 by a specified operation using the input device 14. This equipment search screen 60 is a screen for causing the analysis server 5 to search for the equipment 3 which satisfies desired search conditions.

This equipment search screen 60 is configured by including a search condition setting area 61 and a search result display area 62. Then, the search condition setting area 61 is provided with one or a plurality of search condition setting buttons 70, a search condition add button 71, and a search button 72.

Then, the equipment search screen 60 can display a pulldown menu 73 (73A), in which a plurality of search conditions that can be designated by the user, such as a “Model,” “Operating Time,” and an “Installation Date,” are indicated, by performing a pressing operation, for example, by clicking or tapping the search condition setting button 70.

Moreover, regarding a search condition(s) for which lower-layer search conditions than the search conditions displayed in the pulldown menu 73 (73A) exist (for example, specific areas such as each “Prefecture” regarding the search condition for the “Installation Location”), the equipment search screen 60 can display a pulldown menu 73 (73B), in which a plurality of the lower-layer search conditions for the relevant search condition are indicated, by performing the operation to press a character string representing the relevant search condition in the above-described pulldown menu 73 (73A). On the equipment search screen 60, regarding a search condition(s) for which further lower-layer search conditions exist, a pulldown menu(s) 73 in which the further lower-layer search conditions are indicated can be sequentially displayed in a similar manner.

Consequently, the user can cause the lowest-layer pulldown menu 73, in which a desired search condition is indicated, to be displayed as described above and select the desired search condition indicated in that pulldown menu 73 by performing the pressing operation, thereby making it possible to designate that search condition as a search key when searching the equipment 3. Subsequently, the user can cause the analysis server 5 to execute the search of the equipment identifying information database 20 (FIG. 3) with that search condition (the search condition on which the last pressing operation was performed) as the search key by performing the operation to press the search button 72.

Then, on the equipment search screen 60, information such as the installation location, the production number, and the installation date of each equipment 3 which satisfies the above-described search condition and has been detected by the search processing executed by the analysis server 5 as described above is displayed in a table format within the search result display area 62. Under this circumstance, the search result display area 62 also displays the accumulated operating time acquired from the operation data management table 27 (FIG. 7) regarding each equipment 3 detected by the above-described search.

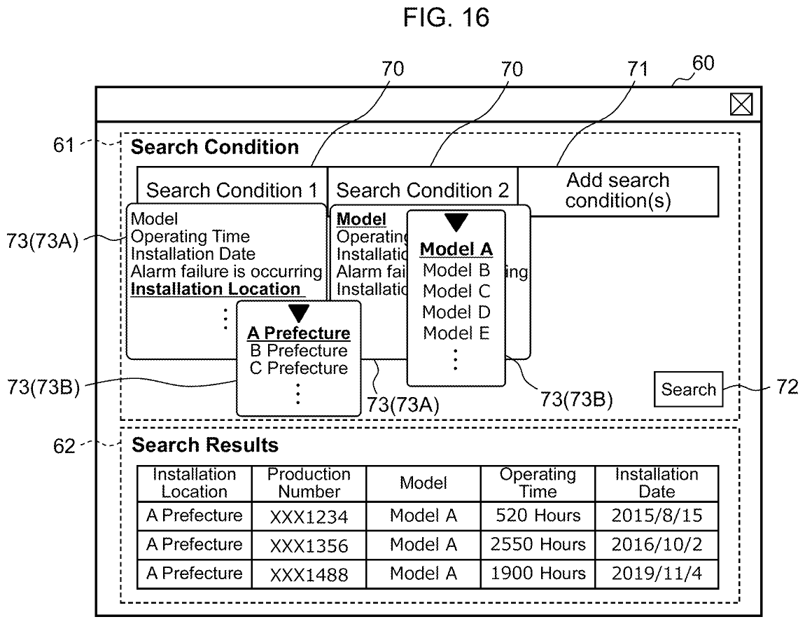

Incidentally, on the equipment search screen 60, a plurality of search conditions can be set. For example, as illustrated in FIG. 16, if two search conditions are to be set, the highest-layer pulldown menu 73 (73A) is displayed by performing the operation to press the search condition setting button 70 at which the character string “Search Condition 1” is indicated, and then the first search condition is set as described above. Subsequently, the highest-layer pulldown menu 73 (73A) is displayed by performing the operation to press the search condition setting button 70 at which the character string “Search Condition 2” is indicated, and then the second search condition is set. Subsequently, the operation to press the search button 72 is performed. As a result, the search for the equipment 3 which satisfies both the two search conditions is performed and the search results are displayed in the search result display area 62.

Moreover, on the equipment search screen 60, one search condition setting button 70 can be added and displayed every time the operation to press the search condition add button 71 is performed. Accordingly, the user can set a desired number of search conditions and search the equipment identifying information database 20 (FIG. 3) for the equipment 3 which satisfies all these search conditions.

### (4) Flows of Various Kinds of Processing Regarding Equipment Analysis Function

Next, an explanation will be provided about specific processing flows of various kinds of processing executed by the analysis server 5 in relation to the above-described equipment analysis function. Incidentally, in the following explanation, a processing subject of the various kinds of processing will be explained as a “program ( . . . unit)” or as a function of part of the program (functional unit); however, practically, it is needless to say that the CPU 10 (FIG. 2) for the analysis server 5 executes that processing according to that program.

(4-1) Equipment Status Diagnosis Processing

FIG. 17 is a flowchart illustrating a flow of a sequence of processing executed by the analysis server 5 when the production number of the object equipment 3 and an instruction to execute the equipment status diagnosis processing by designating the analysis item are given from the user.

When the above-described execution instruction is given to the analysis server 5, the monitoring object equipment identifying information input unit 30A (FIG. 11) for the data input unit 30 firstly reads the equipment name, the model, the installation site address, and the installation date of the object equipment 3 from the equipment identifying information database 20 (FIG. 3) on the basis of the production number of that object equipment 3, which is then designated by the user, and reports them to the equipment status decision unit 31 (FIG. 11). Moreover, along with the above, the analysis item input unit 30B (FIG. 11) for the data input unit 30 reads the necessary data type of each data for the analysis of the analysis item, which is then designated by the user, from the analysis item database 21 (FIG. 4) and reports it to the equipment status decision unit 31 (S1).

The equipment status decision unit 31B for the equipment status decision unit 31 executes equipment status decision processing for deciding the equipment status of the object equipment 3 on the basis of the analysis item reported from the analysis item input unit 30B (“Equipment Status Diagnosis” in this example) (S2). Specific content of the equipment status decision processing will be described later. By means of this equipment status decision processing, the respective equipment statuses of the object equipment 3 and the diagnosis classes to which these equipment statuses belong are decided, respectively, and these pieces of information are reported to the diagnosis result decision unit 32 (FIG. 11) (S2).

Subsequently, the diagnosis score decision unit 32A (FIG. 11) for the diagnosis result decision unit 32 calculates diagnosis scores of the respective diagnosis classes on the basis of the respective equipment statuses of the object equipment 3 and the diagnosis classes, to which these equipment statuses belong, that are reported from the equipment status decision unit 31B, and calculates a diagnosis score of the object equipment indicating the degree of badness of the current status of the object equipment 3 by adding up the calculated diagnosis scores of the respective diagnosis classes (S3).

Next, the classification processing unit 32B (FIG. 11) for the diagnosis result decision unit 32 classifies the object equipment 3 into their corresponding classification groups with respect to the “Model,” the “Area,” and the “Operating Time,” respectively, on the basis of the information such as the equipment name, the model, the installation site address, and the installation date of the object equipment 3, which was reported from the monitoring object equipment identifying information input unit 30A for the data input unit 30, and the operating time of the object equipment 3 which was reported from the equipment status decision unit 31B for the equipment status decision unit 31 (S4).

Furthermore, the ranking processing unit 32C (FIG. 11) for the diagnosis result decision unit 32 performs ranking to decide in which rank in each of the classification groups of the “Model,” the “Area,” and the “Operating Time” the status is bad (S5). Moreover, after or in parallel to this, the diagnosis processing unit 32D for the diagnosis result decision unit 32 executes the judgment processing on the object equipment 3 with respect to each preset diagnosis item (S6).

Subsequently, the data visualization unit 34 visualizes and displays the respective processing results of the ranking processing unit 32C and the diagnosis processing unit 32D for the diagnosis result decision unit 32 collectively on, for example, the analysis result display screen 40 described earlier with reference to FIG. 14 (S7). As a result, this equipment status diagnosis processing terminates.

(4-2) Equipment Status Decision Processing

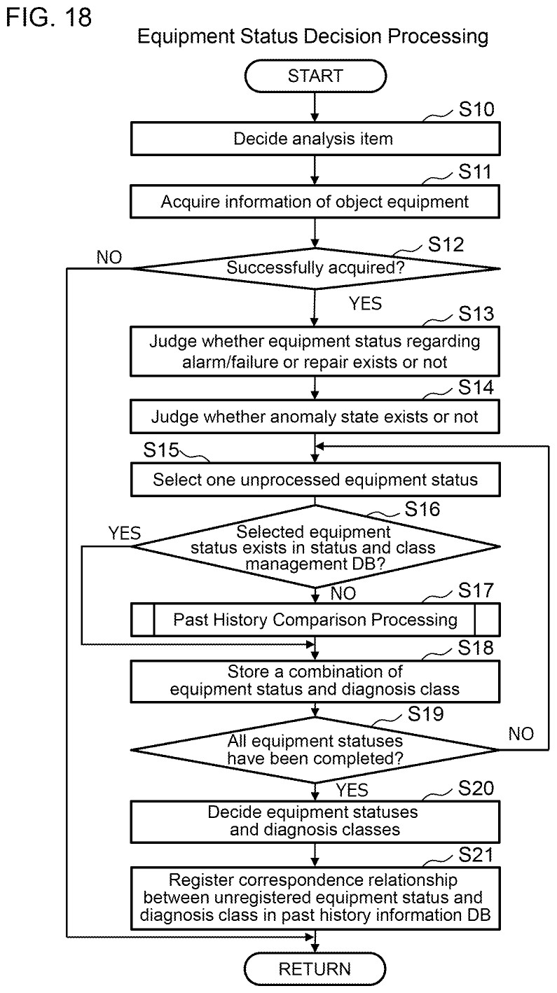

FIG. 18 is a flowchart illustrating specific processing content of the equipment status decision processing executed by the equipment status decision unit 31 (FIG. 11) in step S2 of the equipment status diagnosis processing described earlier with reference to FIG. 17.

Practically, when the equipment status diagnosis processing described earlier with reference to FIG. 17 proceeds to step S2, the equipment status decision processing illustrated in this FIG. 18 is started; and the analysis item decision unit 31A (FIG. 11) for the equipment status decision unit 31 firstly decides, based on the analysis item designated by the user, which was reported from the analysis item input unit 30B (FIG. 11) for the data input unit 30 (FIG. 11) (the equipment status diagnosis in this example), that the analysis item to be then executed should be the equipment status diagnosis. Moreover, the analysis item decision unit 31A reports the equipment status diagnosis which is the decided analysis item, the respective necessary data types of data to perform the equipment status diagnosis, which were reported from the analysis item input unit 30B (the “Alarm/Failure Information,” the “Operation Data,” and the “Repair History Information” in this example), and the production number of the object equipment, which was reported from the monitoring object equipment identifying information input unit 30A for the data input unit 30 (FIG. 11), to the equipment status decision unit 31B (310).

The equipment status decision unit 31B acquires the data of the respective necessary data types, that is, the “Alarm/Failure Occurrence,” the “Operation Data,” and the “Repair History” which are required to perform the equipment status diagnosis, from the alarm/failure information management table 26 (FIG. 6), the operation data management table 27 (FIG. 7), or the repair history management table 28 (FIG. 5) of the equipment information database 22 (FIG. 5), respectively, on the basis of each piece of the aforementioned information reported from the analysis item decision unit 31A (S11).

Subsequently, the equipment status decision unit 31B judges whether or not the data of at least one necessary data type among the “Alarm/Failure Occurrence,” the “Operation Data,” and the “Repair History” was successfully acquired in step S11 (S12).

Obtaining a negative result in this judgment means that there is no equipment status which the object equipment 3 falls under (that is, no anomaly state has occurred at the object equipment 3). Consequently, under this circumstance, the equipment status decision unit 31B terminates this equipment status decision processing and returns to the equipment status diagnosis processing. Incidentally, in this case, there is no equipment status which the object equipment 3 falls under, so that the diagnosis score of the object equipment will be calculated as “0” in the next step S3 of the equipment status diagnosis processing.

On the other hand, if the equipment status decision unit 31B obtains an affirmative result in the judgment in step S12, it judges whether or not the equipment status indicating the alarm issuance or the failure occurrence or the equipment status indicating that the repair was performed has been successfully detected as the past or current equipment status of the object equipment 3 on the basis of the data acquired from the alarm/failure information management table 26 or the repair history management table 28 among the data acquired in step S11 (S13).

Moreover, the equipment status decision unit 31B judges whether or not the anomaly state has been successfully detected as the past or current equipment status of the object equipment 3, on the basis of the operation data acquired from the operation data management table 27 among the data acquired in step S11 (S14).

For example, in step S11, if the internal equipment temperature recognized based on the operation data acquired from the operation data management table 27 is equal to or larger than an upper limit threshold value which is set in advance for the internal equipment temperature, or if the above-described internal equipment temperature is equal to or smaller than a lower limit threshold value which is set in advance for the internal equipment temperature, that operation data is data indicating the anomaly state and, therefore, in such a case, the equipment status decision unit 31B determines that the anomaly state has been successfully detected.

Moreover, in step S11, if the temperature difference between the internal equipment temperature and the ambient temperature as recognized based on the operation data acquired from the operation data management table 27 is equal to or larger than an upper limit threshold value which is set in advance for that temperature difference, or if the above-described temperature difference is equal to or smaller than a lower limit threshold value which is set in advance for that temperature difference, that operation data is data indicating the anomaly state and, therefore, in such a case, the equipment status decision unit 31B determines that the anomaly state has been successfully detected.

Furthermore, in step S11, if the internal equipment pressure recognized based on the operation data acquired from the operation data management table 27 is equal to or larger than an upper limit threshold value which is set in advance for the relevant internal equipment pressure, or if the above-described internal equipment pressure is equal to or smaller than a lower limit threshold value which is set in advance for the relevant internal equipment pressure, the operation data is data indicating the anomaly state and, therefore, in such a case, the equipment status decision unit 31B determines that the anomaly state has been successfully detected.

Subsequently, the equipment status decision unit 31B selects one equipment status regarding which step S16 and subsequent steps have not been processed, from among the equipment statuses detected in step S13 or step S14 (the equipment status regarding the alarm/failure occurrence or the repair, or the anomaly state) (S15) and judges whether or not the selected equipment status (hereinafter referred to as the “selected equipment status”) is registered in the status and class management database 23 (FIG. 8) (S16).

Then, if the equipment status decision unit 31B obtains an affirmative result in this judgment, it stores a combination of such selected equipment status with the diagnosis class which is associated with the selected equipment status in the status and class management database 23 (S17), and then proceeds to step S19.

On the other hand, if the equipment status decision unit 31B obtains a negative result in the judgment in step S16, it extracts an equipment status which is closest to the selected equipment status from among the equipment statuses registered in the past history information database 24 (FIG. 9) and stores a combination of the extracted equipment status and the diagnosis class which is associated with that equipment status in the past history information database 24 (S18).

Next, the equipment status decision unit 31B judges, regarding all the equipment statuses detected in step S13 or step S14, whether the execution of the processing in step S16 to step S18 has been completed or not (S19). Then, if the equipment status decision unit 31B obtains a negative result in this judgment, it returns to step S15 and then repeats the processing from step S15 to step S19 by sequentially switching the equipment status to be selected in step S15 to another applicable equipment status regarding which step S16 and subsequent steps have not been processed.

Then, if the equipment status decision unit 31B eventually obtains an affirmative result in step S19 by finishing the execution of step S16 to step S18 regarding all the equipment statuses detected in step S13 or step S14, it decides all the equipment statuses and the diagnosis classes, whose combinations have been stored in step S18 until then, as the equipment statuses of the object equipment 3 and the diagnosis classes to which such equipment statuses belong (S20).

Furthermore, if there is any correspondence relationship between an equipment status and its diagnosis class, which is not registered in the status and class management database 23 (FIG. 8), among the correspondence relationships between the respective equipment statuses of the object equipment 3 and their diagnosis classes which were decided in step S20, the equipment status decision unit 31B registers that correspondence relationship between the equipment status and the diagnosis class in the past history information database 24 (FIG. 9) (S21). Then, the equipment status decision unit 31B terminates this equipment status decision processing.

(4-3) Past History Comparison Processing

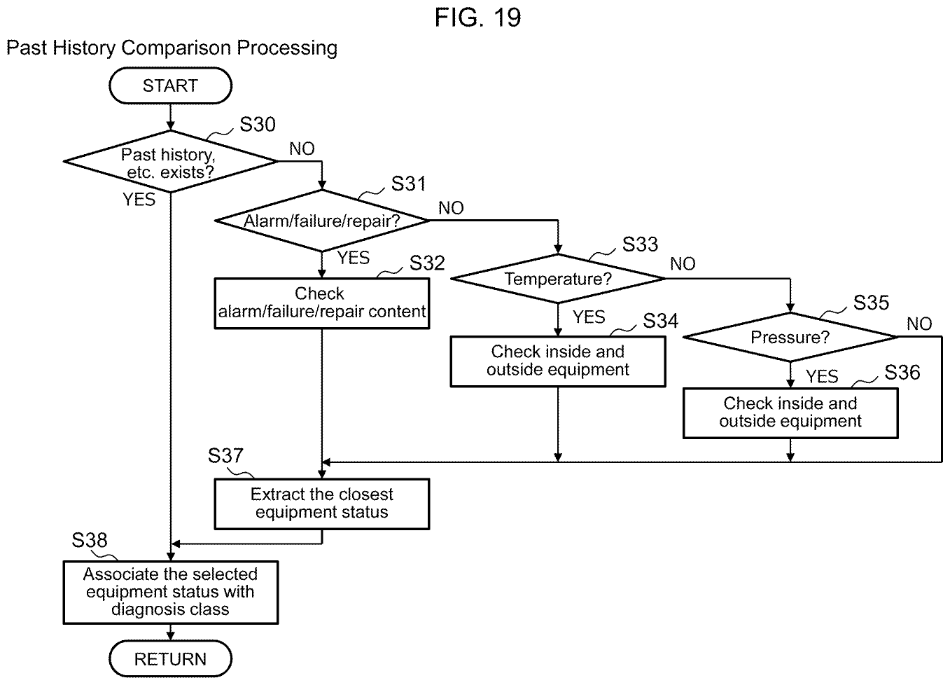

FIG. 19 illustrates specific processing content of the equipment status decision unit 31B in step S17 of the equipment status decision processing described above with reference to FIG. 18. When the equipment status decision unit 31B proceeds to step S17 of the equipment status decision processing, it starts past history comparison processing illustrated in this FIG. 19 and firstly judges whether the equipment status selected in step S15 of the equipment status decision processing (FIG. 18) (the selected equipment status) is registered in the past history information database 24 (FIG. 9) or not (S30).

If the equipment status decision unit 31B obtains an affirmative result in this judgment, it associates the selected equipment status with the diagnosis class which is associated with the selected equipment status in the past history information database 24 (S38). Then, the equipment status decision unit 31B terminates this past history comparison processing and returns to the equipment status decision processing. Therefore, in this case, a combination of the selected equipment status and the diagnosis class which are then associated with each other will be stored in the next step S18. The same applies hereinafter.

On the other hand, if the equipment status decision unit 31B obtains a negative result in the judgment in step S30, it estimates an equipment status whose content is closest to that of the selected equipment status from among the equipment statuses registered in the status and class management database 23 (FIG. 8) or the past history information database 24 (FIG. 9) by executing step S31 to step S37 described below.

Specifically, the equipment status decision unit 31B firstly whether or not the selected equipment status is an equipment status regarding the alarm/failure or the repair (S31). Then, if the equipment status decision unit 31B obtains an affirmative result in this judgment, it checks the specific content of the selected equipment status (the alarm/failure/repair content) (S32) and extracts an equipment status whose status is closet to that of the selected equipment status from among the equipment statuses registered in the status and class management database 23 or the past history information database 24 (S37). Furthermore, the equipment status decision unit 31B associates the equipment status extracted in step S37 with the diagnosis class, which is associated in the past history information database 24, as the diagnosis class of the extracted equipment status (S38), and then terminates this past history comparison processing and returns to the equipment status decision processing.

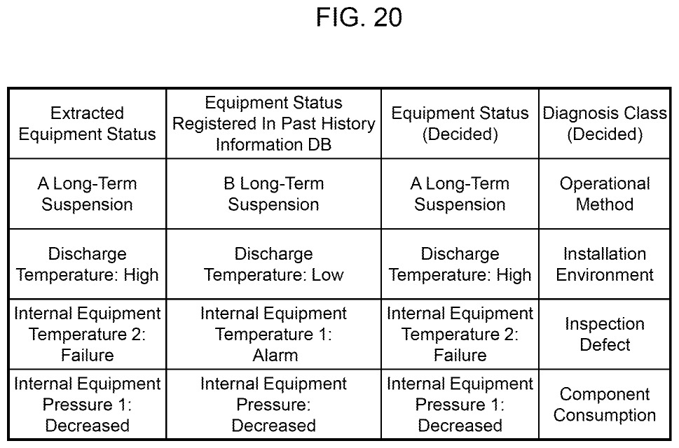

For example, if the selected equipment status is “A Long-Term Suspension” as in an example indicated in the first row in FIG. 20 and an equipment status which is closet to “A Long-Term Suspension” among the equipment statuses registered in the past history information database 24 is “B Long-Term Suspension,” the equipment status decision unit 31B will associate the diagnosis class called the “Operational Method,” which is associated with the equipment status “B Long-Term Suspension” in the past history information database 24, with “A Long-Term Suspension” which is the selected equipment status.

On the other hand, if the equipment status decision unit 31B obtains a negative result in the judgment in step S31, it judges whether the selected equipment status is an equipment status regarding the temperature or not (S33). Then, if the equipment status decision unit 31B obtains an affirmative result in this judgment, it checks the specific content of the selected equipment status (the specific anomaly state of the temperature) (S34) and extracts an equipment status whose content is closest to that of the selected equipment status from among the equipment statuses registered in the status and class management database 23 or the past history information database 24 (S37). Furthermore, the equipment status decision unit 31B associates the diagnosis class, which is associated with the equipment status extracted in step S37 in the past history information database 24, as the diagnosis class of the extracted equipment status (S38) and then terminates this past history comparison processing and returns to the equipment status decision processing.

For example, if the selected equipment status is “Discharge Temperature: High” as in an example indicated in the second row in FIG. 20 and an equipment status which is closest to the “Discharge Temperature: High” among the equipment statuses registered in the past history information database 24 is “Discharge Temperature: Low,” the equipment status decision unit 31B will associate the diagnosis class called the “Installation Environment,” which is associated with the equipment status “Discharge Temperature: Low” in the past history information database 24, with the “Discharge Temperature: High” which is the selected equipment status.

Furthermore, if the extracted equipment status is “Internal Equipment Temperature 2: Failure” as in an example indicated in the third row in FIG. 20 and an equipment status which is closest to the “Internal Equipment Temperature 2: Failure” among the equipment statuses registered in the past history information database 24 is “Internal Equipment Temperature 1: Alarm,” the equipment status decision unit 31B will associate the diagnosis class called the “Inspection Defect,” which is associated with “Internal Equipment Temperature 1: Alarm” in the past history information database 24, with the “Internal Equipment Temperature 2: Failure” which is the selected equipment status.

On the other hand, if the equipment status decision unit 31B obtains a negative result in the judgment in step S33, it judges whether or not the selected equipment status is an equipment status regarding the pressure (S35). Then, if the equipment status decision unit 31B obtains an affirmative result in this judgment, it checks the specific content of the selected equipment status (the specific anomaly state of the pressure) (S36) and extracts an equipment status which is closest to the content of the selected equipment status from among the equipment statuses registered in the status and class management database 23 or the past history information database 24 (S37). Furthermore, the equipment status decision unit 31B: associates the diagnosis class, which is associated with the equipment status extracted in step S37 in the past history information database 24, with the diagnosis class of the extracted equipment status (S38); and then terminates this past history comparison processing and returns to the equipment status decision processing.

For example, as illustrated in an example in the fourth row in FIG. 20, if the extracted equipment status is “Internal Equipment Pressure 1: Decreased” and an equipment status which is closest to “Internal Equipment Pressure 1: Decreased” among the equipment statuses registered in the past history information database 24 is “Internal Equipment Pressure: Decreased,” the equipment status decision unit 31B will associate the diagnosis class called “Component Consumption,” which is associated with the “Internal Equipment Pressure: Decreased” in the past history information database 24, with the “Internal Equipment Pressure 1: Decreased” which is the selected equipment status.

On the other hand, if the equipment status decision unit 31B obtains a negative result in the judgment in step S35, it extracts an equipment status which closest to the content of the selected equipment status from among the equipment statuses registered in the status and class management database 23 or the past history information database 24 (S37). Then, the equipment status decision unit 31B associates the diagnosis class, which is associated with the equipment status extracted in step S37 in the status and class management database 23 or the past history information database 24, as the diagnosis class of the selected equipment status (S38) and then terminates this past history comparison processing and returns to the equipment status decision processing.

### (5) Advantageous Effects of this Embodiment

The monitoring system 1 according to this embodiment described above evaluates and visualizes the current status of the object equipment 3 as the diagnosis score, so that it is possible to present the current status of the object equipment 3 to the user on the basis of this diagnosis score in an easily comprehensible manner.

Also, this monitoring system 1 displays the rank of the object equipment 3 in the classification group on the basis of the above-described diagnosis score, so that the user can objectively recognize the status of the object equipment 3 as compared with other equipment 3.

### (6) Other Embodiments

Incidentally, the aforementioned embodiment has described the case where the present invention is applied to the monitoring system 1 for the industrial equipment as the monitoring object; however, the present invention is not limited to this example and can be applied to a wide variety of monitoring systems for equipment other than the industrial equipment as monitoring objects.

Also, the aforementioned embodiment has described the case where the equipment analysis function of this embodiment in mounted in one analysis server 5; however, the present invention is not limited to this example and the above-mentioned equipment analysis function may be distributed to and mounted in a plurality of computer devices which are mutually connected via a network, and the equipment analysis function according to this embodiment may be implemented by making these computer devices cooperating with each other.

### INDUSTRIAL AVAILABILITY

The present invention can be applied to monitoring apparatuses for monitoring the status of equipment such as industrial equipment.

### REFERENCE SIGNS LIST

1: monitoring system
3: equipment
5: analysis server
10: CPU
20: equipment identifying information database
21: analysis item database
22: equipment information database
23: status and class management database
24: past history information database
25: diagnosis result database
26: alarm/failure information management table
27: operation data management table
28: repair history management table
29: maintenance history management table
30: data input unit
30A: monitoring object equipment identifying information input unit
30B: analysis item input unit
31: equipment status decision unit
31A: analysis item decision unit
31B: equipment status decision unit
32: diagnosis result decision unit
32A: diagnosis score decision unit
32B: classification processing unit
32C: ranking processing unit
33: data output unit
34: data visualization unit
40: equipment search screen
60: analysis result display screen

1. A monitoring apparatus for monitoring equipment which is a monitoring object, the monitoring apparatus comprising:
an input unit that accepts designation of equipment identifying information for identifying object equipment that is the equipment which is an analysis object, and an analysis item to be analyzed regarding the object equipment;
an equipment status decision unit that acquires data of a data type which is required to analyze the analysis item accepted by the input unit and decides a current equipment status or statuses of the object equipment based on the acquired data;
a diagnosis result decision unit that calculates a diagnosis score for evaluating a current status of the object equipment as a score based on the equipment status of the object equipment as decided by the equipment status decision unit, and decides a diagnosis result of the object equipment on the basis of the calculated diagnosis score; and
a visualization unit that visualizes and presents the diagnosis result of the object equipment decided by the diagnosis result decision unit.

2. The monitoring apparatus according to claim 1,
wherein the diagnosis result decision unit ranks the current status of the object equipment in a specified classification group configured from the equipment which is a plurality of monitoring objects on the basis of the calculated diagnosis score of the object equipment; and
wherein the visualization unit visualizes a rank of the object equipment in the classification group as ranked by the diagnosis result decision unit.

3. The monitoring apparatus according to claim 1, further comprising a database in which a correspondence relationship between the equipment statuses and causes for the equipment statuses is stored,
wherein a score is set to each of the causes;
wherein the equipment status decision unit decides all the equipment statuses, which the object equipment falls under, as the equipment statuses of the object equipment; and
wherein the diagnosis result decision unit calculates a total score with respect to each of the causes by multiplying a quantity of the equipment statuses of the object equipment associated with the cause by the score that is set to the cause, and calculates the diagnosis score of the object equipment by adding up the calculated total score of each cause.

4. The monitoring apparatus according to claim 3,
wherein the score according to seriousness of the equipment status associated with the cause is set to each cause.

5. The monitoring apparatus according to claim 3,
wherein when the equipment status decision unit decides the equipment status which is not registered in the database to be the equipment status of the object equipment, the equipment status decision unit estimates the cause for the equipment status on the basis of the correspondence relationship between the equipment status and the cause, which is registered in the database.

6. The monitoring apparatus according to claim 1,
wherein the diagnosis result decision unit calculates a degree of deterioration over time of the object equipment as deterioration over time on the basis of the diagnosis score, which evaluates the current status of the object equipment as a score, and the diagnosis score which evaluates a past status of the object equipment as a score; and
wherein the visualization unit visualizes the deterioration over time of the object equipment which is calculated by the diagnosis result decision unit.

7. A monitoring method executed by a monitoring apparatus for monitoring equipment which is a monitoring object, the monitoring method comprising:
a first step of accepting designation of equipment identifying information for identifying object equipment that is the equipment which is an analysis object, and an analysis item to be analyzed regarding the object equipment;
a second step of acquiring data of a data type which is required to analyze the accepted analysis item and deciding a current equipment status or statuses of the object equipment based on the acquired data;
a third step of calculating a diagnosis score for evaluating a current status of the object equipment as a score based on the equipment status of the decided object equipment, and deciding a diagnosis result of the object equipment on the basis of the calculated diagnosis score; and
a fourth step of visualizing the decided diagnosis result of the object equipment.

8. The monitoring method according to claim 7,
wherein in the third step, the current status of the object equipment in a specified classification group configured from the equipment which is a plurality of monitoring objects is ranked on the basis of the calculated diagnosis score of the object equipment; and
wherein in the fourth step, a rank of the ranked object equipment in the classification group is visualized.

9. The monitoring method according to claim 7,
wherein the monitoring apparatus has a database in which a correspondence relationship between the equipment statuses and causes for the equipment statuses is stored,
wherein a score is set to each of the causes;
wherein in the second step, all the equipment statuses, which the object equipment falls under, are decided as the equipment statuses of the object equipment; and
wherein in the third step, a total score is calculated with respect to each of the causes by multiplying a quantity of the equipment statuses of the object equipment associated with the cause by the score that is set to the cause, and the diagnosis score of the object equipment is calculated by adding up the calculated total score of each cause.

10. The monitoring method according to claim 9,
wherein the score according to seriousness of the equipment status associated with the cause is set to each cause.

11. The monitoring method according to claim 9,
wherein in the second step, when the equipment status which is not registered in the database is decided to be the equipment status of the object equipment, the cause for the equipment status is estimated on the basis of the correspondence relationship between the equipment status and the cause, which is registered in the database.

12. The monitoring method according to claim 7,
wherein in the third step, a degree of deterioration over time of the object equipment is calculated as deterioration over time on the basis of the diagnosis score, which evaluates the current status of the object equipment as a score, and the diagnosis score which evaluates a past status of the object equipment as a score; and
wherein in the fourth step, the calculated deterioration over time of the object equipment is visualized.
